(19) United States
(12) Patent Application Publication
(10) Pub. No.: US 2021/0012366 A1
(43) Pub. Date: Jan. 14, 2021

(54) SYSTEMS AND METHODS FOR ASSESSING MERCHANT PERFORMANCE USING REAL-TIME CONSUMER TRANSACTION FEEDBACK

(71) Applicant: MBP Insights, Inc., Singapore (SG)

(72) Inventor: James J. Simon, Singapore (SG)

(73) Assignee: MBP Insights, Inc., Singapore (SG)

(21) Appl. No.: 17/031,517

(22) Filed: Sep. 24, 2020

Related U.S. Application Data
(63) Continuation-in-part of application No. 16/559,291, filed on Sep. 3, 2019.
(60) Provisional application No. 62/905,513, filed on Sep. 25, 2019.
(60) Provisional application No. 62/870,558, filed on Jul. 3, 2019.
(60) Provisional application No. 62/861,921, filed on Jun. 14, 2019.

(51) Int. Cl. G06Q 30/02

(52) U.S. Cl. CPC G06Q 30/0217; G06Q 30/0282; G06Q 30/0205; G06Q 30/0203

(57) ABSTRACT

Systems, methods, and storage media for operating a consumer feedback incentive system are disclosed. Exemplary implementations may: transmit one or more incentive offers to one or more computing devices associated with one or more consumers; receive real-time survey feedback data from the one or more computing devices associated with the one or more consumers; provide a merchant analytics platform to a merchant associated with the one or more incentive offers, the merchant analytics platform comprising a user interface, wherein the user interface of the merchant analytics platform comprises a plurality of analytics display sections; and receive, via a user interface, one or more comparative representations organized according to selections made by the merchant.

### CROSS-REFERENCE TO RELATED APPLICATIONS

The present application is a continuation-in-part of and claims priority to U.S. application Ser. No. 16/559,291 filed Sep. 3, 2019 titled “System and Method for Receiving Real-Time Consumer Transactional Feedback” which claims priority to U.S. Provisional Application Nos. 62/861,921 filed Jun. 14, 2019 and 62/870,558 filed Jul. 3, 2019. The present application further claims priority to U.S. Provisional Patent Application No. 62/905,513 filed Sep. 25, 2019, titled “Systems and Methods for Assessing Merchant Performance Using Real-Time Consumer Transaction Feedback”. All applications are incorporated by reference herein as if reproduced in full below.

### TECHNICAL FIELD

This disclosure relates generally to technological improvements in the fields of electronic collection and analytics of customer satisfaction data. More specifically, the disclosure describes systems and methods for providing an improved comparative merchant analytics platform that incentivizes rapid responses in connection with a system for improving response rates and quality of responses to consumer surveys.

### BACKGROUND

Many online and brick-and-mortar merchants, retailers, and service providers rely on consumer feedback in order to help them make business decisions. For example, a merchant may seek information about which products are popular with the consumer and which are not, and why. A retailer or service provider may be able to improve customer service perceptions in a dramatic way by using customer surveys to identify recurring customer problems or complaints. With respect to physical store versus online transactions, some retailers may be interested in understanding similarities in and differences between a consumer's expectations and experiences. Such feedback, when gathered accurately and quickly, can help a business run more efficiently and profitably.

Conventional methods of surveying customers and collecting customer feedback do not provide high-quality and/or timely information for a variety of reasons. For example, retailers often request customer feedback at the register or via a paper store receipt. In-person requests for feedback tend to discourage criticism and candid suggestions for improvement (because the consumer must provide the criticism to another person), while surveys tied to paper store receipts are usually inconvenient to the consumer because they require the consumer to save the receipt and access it later, and then, upon such access, to manually log into a web site and/or enter a code number. Many consumers simply do not notice such a request to provide feedback, even when an incentive such as free merchandise or a contest entry is offered. Even for those who do notice it, the perceived time required to attend to the feedback request, for a reward perceived to have negligible value to them (or an almost-zero chance of winning), motivates the consumer to spend his or her time in other ways, and not to provide the feedback.

In many cases, traditional feedback collection methods are overly burdensome to the consumer, resulting in poor, inaccurate or no feedback to the merchant because the process requires several different types of platforms and media—including paper receipts, websites maintained by third-party data aggregators or otherwise separate from the merchant's primary website, unique login or QR codes, etc. Traditional processes typically also require a significant time investment for which the typical consumer is not adequately incentivized to participate. Further, where incentives are offered in traditional processes, there is typically a lack of immediacy in delivery of the reward—a consumer often has to wait for a separate department or entity to contact them by mail, telephone, or email with still further instructions about how to collect a voucher, coupon, or other reward. This lack of immediacy is a major or even a complete disincentive to the consumer to provide the feedback. Further, any delay in response time may result in the value of the information to the merchant being significantly reduced or completely eliminated. In addition to the known time decay value of information, delayed feedback response times may, as just one example, make it difficult or impossible for the merchant to investigate and correct the particular circumstances that caused a consumer to respond with negative feedback.

Consumers who do find and respond to traditional survey requests are often not representative of the public or the particular business's customer base, often skewing toward disgruntled customers, customers in desperate need of money or a reward or who believe they will win an improbable prize, and/or those who are much more likely, for one reason or another, to read a store receipt. When feedback is given, the business often receives the information long after the purchase, reducing the reliability and insightfulness of—and ability to take actions based on—the feedback data. Even when feedback is received, very little information is typically communicated back to the merchant, and deeper analysis of feedback information is sparse or nonexistent—as well as almost always unrecoverable even if the desire for conducting such analysis exists.

Additionally, many consumers have come to mistrust traditional marketing and/or sales techniques. For example, many “Generation Z” or Millennial consumers do not consciously respond to and may even “tune out” traditional marketing and advertisements, instead seeking out sources perceived as, for example, more authentic, more trustworthy, more proximate, and/or more reliable. Social media contacts are often considered to be more reliable and trustworthy recommenders of goods and services than other parties with whom the consumer has no social or other connection. Many consumers seek people with similar interests, experiences, and lifestyles (“cohorts”) when considering how and where to spend their money on goods and services. Social media-based marketing, and especially so-called “viral” marketing campaigns are among the most efficient ways to reach new and existing consumers.

### SUMMARY

In general, the present disclosure provides an improved merchant analytics platform for comparing merchant customer satisfaction performance in connection with a system for improving response rates and quality of responses to consumer surveys. One aspect of the present disclosure relates to a consumer feedback incentive system configured to incentivize and receive consumer feedback, prepare various analyses of the received feedback data, and provide a merchant analytics platform (sometimes referred to herein as a merchant “dashboard”) to a merchant, the merchant analytics platform configured to include the presentation of comparative merchant customer satisfaction performance data.

The system may include one or more hardware processors configured by machine-readable instructions. The processors(s) may be configured to transmit one or more incentive offers to one or more computing devices associated with one or more consumers. The processor(s) may be configured to receive real-time survey feedback data from the one or more computing devices associated with the one or more consumers. The processor(s) may be further configured to provide a merchant analytics platform to a merchant associated with the one or more incentive offers, the merchant analytics platform comprising a user interface, wherein the user interface of the merchant analytics platform comprises a plurality of analytics display sections. The processor(s) may be further configured to receive one or more selections from the merchant, the selections representing attributes of one or more comparative representations the merchant wishes to view. The processor(s) may be further configured to display, via the user interface, at least one of the one or more comparative representations.

In some implementations of the system, information may be delivered in any one or a combination of various forms—for example, visual forms, auditory forms, haptic forms, tactile forms, or any other appropriate form of information delivery as would be apparent to a person having ordinary skill in the art. In some implementations of the system, at least one of the one or more comparative representations may comprise at least a portion of the real-time survey feedback associated with the merchant compared with feedback data associated with one or more competitors of the merchant.

In various implementations of the system, the one or more comparative representations may comprise at least one representation selected from: a comparison of at least a portion of the real-time survey feedback data associated with the merchant to feedback data associated with one or more other merchants in a similar industry as the merchant; a comparison of at least a portion of the real-time survey feedback data associated with the merchant to feedback data associated with one or more other merchants in a specified geographic area; and a comparison of at least a portion of the real-time survey feedback data associated with the merchant to feedback data associated with one or more other merchants selected by the merchant.

In some implementations of the system, one or more of the selections may comprise a time-based limitation. In some implementations of the system, at least one of the one or more comparative representations may comprise a comparison of the merchant's performance to one or more other stores, e.g. franchises or company-owned stores, of the merchant. In some implementations of the system, one or more of the selections may comprise a geographical limitation. In some implementations of the system, at least one of the one or more comparative representations may comprise a graphical presentation of at least some of the real-time survey feedback data.

In some implementations of the system, at least one of the plurality of analytics display sections may be configurable by the merchant. In some implementations of the system, the graphical user interface may be displayed on a mobile application of a mobile device associated with the merchant. In some implementations of the system, the graphical user interface may be displayed in a web browser.

Another aspect of the present disclosure relates to a method of operating an analytics platform of a consumer feedback incentive system. The method may include transmitting one or more incentive offers to one or more computing devices associated with one or more consumers. The method may further include receiving real-time survey feedback data from the one or more computing devices associated with the one or more consumers.

The method may further include providing a merchant analytics platform to a merchant associated with the one or more incentive offers, the merchant analytics platform comprising a user interface, wherein the user interface of the merchant analytics platform comprises a plurality of analytics display sections. The method may further include receiving one or more selections from the merchant, the selections representing attributes of one or more comparative representations the merchant wishes to view. The method may further include displaying, via the user interface, at least one of the one or more comparative representations.

In some implementations of the method, at least one of the one or more comparative representations may comprise at least a portion of the real-time survey feedback associated with the merchant compared with feedback data associated with one or more competitors of the merchant.

In some implementations of the method, the one or more comparative representations may comprise at least one representation selected from: a comparison of at least a portion of the real-time survey feedback data associated with the merchant to feedback data associated with one or more other merchants in a similar industry as the merchant; a comparison of at least a portion of the real-time survey feedback data associated with the merchant to feedback data associated with one or more other merchants in a specified geographic area; and a comparison of at least a portion of the real-time survey feedback data associated with the merchant to feedback data associated with one or more other merchants selected by the merchant.

In some implementations of the method, one or more of the selections may comprise a time-based limitation. In some implementations of the method, at least one of the one or more comparative representations may comprise a comparison of the merchant's performance to one or more other stores, e.g. franchises or company-owned stores, of the merchant. In some implementations of the method, one or more of the selections may comprise a geographical limitation.

In some implementations of the method, at least one of the plurality of analytics display sections may be configurable by the merchant. In some implementations of the method, the graphical user interface may be displayed on a mobile application of a mobile device associated with the merchant. In some implementations of the method, the graphical user interface may be displayed in a web browser.

Yes another aspect of the present invention relates to a non-transient computer-readable storage medium having instructions stored thereon, the instructions being executable by one or more processors to perform a method for operating a consumer feedback incentive system. The method may include transmitting one or more incentive offers to one or more computing devices associated with one or more consumers. The method may further include receiving real-time survey feedback data from the one or more computing devices associated with the one or more consumers. The method may further include providing a merchant analytics platform to a merchant associated with the one or more incentive offers, the merchant analytics platform comprising a user interface, wherein the user interface of the merchant analytics platform comprises a plurality of analytics display sections. The method may further include receiving one or more selections from the merchant, the selections representing attributes of one or more comparative representations the merchant wishes to view. The method may further include displaying, via the user interface, at least one of the one or more comparative representations.

According to some embodiments of the non-transient computer-readable storage medium, at least one of the one or more comparative representations may comprise at least a portion of the real-time survey feedback associated with the merchant compared with feedback data associated with one or more competitors of the merchant.

According to some embodiments of the non-transient computer-readable storage medium, the one or more comparative representations may comprise at least one representation selected from: a comparison of at least a portion of the real-time survey feedback data associated with the merchant to feedback data associated with one or more other merchants in a similar industry as the merchant; a comparison of at least a portion of the real-time survey feedback data associated with the merchant to feedback data associated with one or more other merchants in a specified geographic area; and a comparison of at least a portion of the real-time survey feedback data associated with the merchant to feedback data associated with one or more other merchants selected by the merchant.

Other technical features may be readily apparent to one skilled in the art from the following figures, descriptions, and claims. These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases. Throughout this disclosure, the terms “consumer,” “customer,” and any similar terms or phrases are used interchangeably to refer to an individual or entity that has engaged in, will engage in, is engaging in, or may engage in any transaction (e.g. a purchase, sale, trade, barter, etc.) with another party. In particular, a “consumer” or “customer” may include any individual or entity that purchases or otherwise avails itself of the goods and/or services of a merchant, retailer, or service provider. Similarly, while the term “merchant” is used prominently throughout, it should be understood that the terms “merchant,” “retailer,” “service provider” and similar terms are used interchangeably throughout this disclosure to refer to an individual or entity that sells or otherwise provides goods or services.

An “incentive offer” refers to an offer by a party to provide something of monetary or other value in exchange for another party's action. An “incentive” for purposes of this disclosure may include anything intended or believed by one party to increase the likelihood that another party will act in a certain way or provide something of value, regardless of whether the likelihood is actually increased. In particular, an “incentive offer” may be made by a merchant to a consumer or prospective consumer in an attempt to induce the consumer or prospective consumer to act—for example and without limitations, to provide feedback about the merchant. A “gift incentive” or “gift incentive offer” refers to a potential reward made available to a consumer for transfer to a third party, such as another consumer or prospective consumer. In various implementations, a “gift incentive” or “gift incentive offer” may refer to an immediate reward made available to the third party—as in, for example, the case of a coupon redeemable for a free item at a particular retailer—or a conditional reward made available to the third party—for example, an offer that requires some action on the part of the third party before a reward will be bestowed. In some embodiments, the universe of available gift incentives and gift incentive offers may be identical to or substantially overlap with the universe of offers and rewards available in connection with “incentive offers” to established consumers. In some embodiments, the universe of available gift incentives and gift incentive offers may also include additional or exclusive offer terms or rewards made available only as gift incentives.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates a high-level component diagram of an illustrative system architecture, according to some embodiments of this disclosure.

FIG. 2 illustrates details of an example consumer profile according to various embodiments.

FIG. 3 illustrates details of an example incentive selection module according to various embodiments.

FIG. 4 illustrates a partial list of available merchant incentive preferences according to various embodiments.

FIG. 5 illustrates example consumer device applications screens according to some embodiments of the present invention.

FIG. 6 illustrates an example merchant dashboard display according to some embodiments of the present invention.

FIG. 7 illustrates another example merchant dashboard display according to some embodiments of the present invention.

FIG. 8 illustrates an example merchant dashboard display according to some embodiments of the present invention.

FIG. 9 illustrates example merchant mobile dashboard displays according to some embodiments of the present invention.

FIG. 10 represents a flowchart for a method of receiving real-time consumer transactional feedback according to some embodiments of this disclosure.

FIG. 11 represents a flowchart for a method of operating a consumer feedback system that includes a comparative merchant analytics platform, according to some embodiments of this disclosure.

### DETAILED DESCRIPTION

Improvement is desired in the quantity, quality, and timeliness of consumer satisfaction data as well as in comparative representations of such data. Further improvement is desired with respect to the analytical and display capabilities of a merchant platform for motivating, receiving, incentivizing, monitoring, and studying consumer feedback.

By leveraging modern technological hardware to incentivize prompt responses to customer satisfaction surveys and analyze the received feedback, merchants, retailers, and service providers can maximize their efficiency and profits. Conventional methods of surveying customers and collecting customer feedback do not provide high-quality information for a variety of reasons. For example, retailers often request customer feedback at the register or via a paper store receipt. In-person requests for feedback tend to discourage criticism and candid suggestions for improvement, while surveys tied to paper store receipts are usually inconvenient to the consumer because they require the consumer to save the receipt and access it later, often to manually log into a web site and/or enter a code number. Many consumers simply do not notice such a request to provide feedback, even when an incentive such as free merchandise or a contest entry is offered. Consumers who do find and respond to such survey requests are often not representative of the public or the particular business's customer base, often skewing toward disgruntled customers or those who are much more likely, for one reason or another, to read a store receipt. When feedback is given, the business often receives the information long after the purchase, reducing the reliability and insightfulness of—and ability to take actions based on—the feedback data.

Aspects of the present disclosure relate to embodiments that overcome the shortcomings described above. The present disclosure relates in part to incentivizing rapid responses by providing an improved merchant analytics platform in connection with a system for improving response rates and quality of responses to consumer surveys. The present disclosure also relates to incentivizing and receiving real-time, near-time, or batch consumer transactional feedback. Throughout this disclosure, references to “real-time” responses should be understood to include responses made in a relatively short amount of time after receipt of a survey or other request for feedback, but shall not be construed to strictly require an immediate response.

In addition to providing systems and methods for incentivizing consumer survey participation and collecting more data and more reliable consumer feedback data promptly, the present disclosure describes evaluating the salience of transaction data, consumer data, and feedback and survey data. With respect to evaluating various types of data and profiles as described in further detail herein, the systems and methods may include consideration of weighted averages, nonparametric ranking methods, Bayesian analyses, Markovian processes and analyses, and other types and methods of statistical and data analysis, as appropriate. In general, references to “data” and related concepts in this disclosure should be understood to refer to plain text data, encrypted or hashed data, data stored or transmitted by any other technologically feasible format not specifically named here, or any combination of formats thereof.

The disclosure additionally provides systems and methods for promoting goods and services of a merchant by making available gift incentives that may, for example, be sent by an existing customer who has provided real-time feedback to prospective consumers of the goods or services. For example, a satisfied customer may receive both a reward for giving prompt feedback and an opportunity to gift one or more incentives to the consumer's social media contacts. A merchant may specify one or more cohorts to target for such gifted incentives. A cohort may be defined in various ways, for example based on demographic or psychographic data or on information associated with one or more lifestyle classifications or taxonomies. A merchant may also define one or more limits on the number and types of gifted incentives available. For example, a merchant may define a total maximum number of gifted incentives available, and/or set numerical- or time-based limits on how many gift incentives each consumer (or a particular consumer) may acquire or transfer. The social media nature of the gifted incentive may be intended to provoke a type of “viral” marketing based on consumers' trust of recommendations made by friends, acquaintances, and peers over recommendations made by the use of more traditional marketing techniques. As discussed elsewhere herein, recommendations of peers, friends, family, and social media contacts may be perceived as, for example, more authentic, more trustworthy, more proximate, and/or more reliable than traditional marketing or advertising.

Artificial intelligence and machine learning bring exciting new technical, operational and heuristic insights and possibilities to the fields of discussion. It should also be understood that, as part of the portions of this disclosure related to data collection and analysis (e.g. collecting consumer feedback, building profiles of actual or desired consumers, identifying purchasing trends, etc.) that various artificial intelligence and/or machine learning principles, as would be apparent to one having ordinary skill in those fields, may be applied to determine the methods of and/or enhance the data analysis and/or uncover additional insights. As one example, machine learning may be employed to discern the likelihood of a particular incentive offer resulting in a specific consumer or type of consumer participating in giving feedback about a transaction. Such a determination may be made using a variety of input factors, such as the past behavior of a specific consumer and/or consumers sharing particular attributes or characteristics, including derived or inferred attributes. In some embodiments, various parameters may, in general, be ranked according to an expected likelihood of compatibility. For example, all available incentives could be ranked for likelihood of effectiveness at the time of a transaction based on numerous factors including but not limited to demographic and psychographic attributes of the consumer, geographical location of the point of sale, time of day, type of goods or services involved in the transaction, etc.

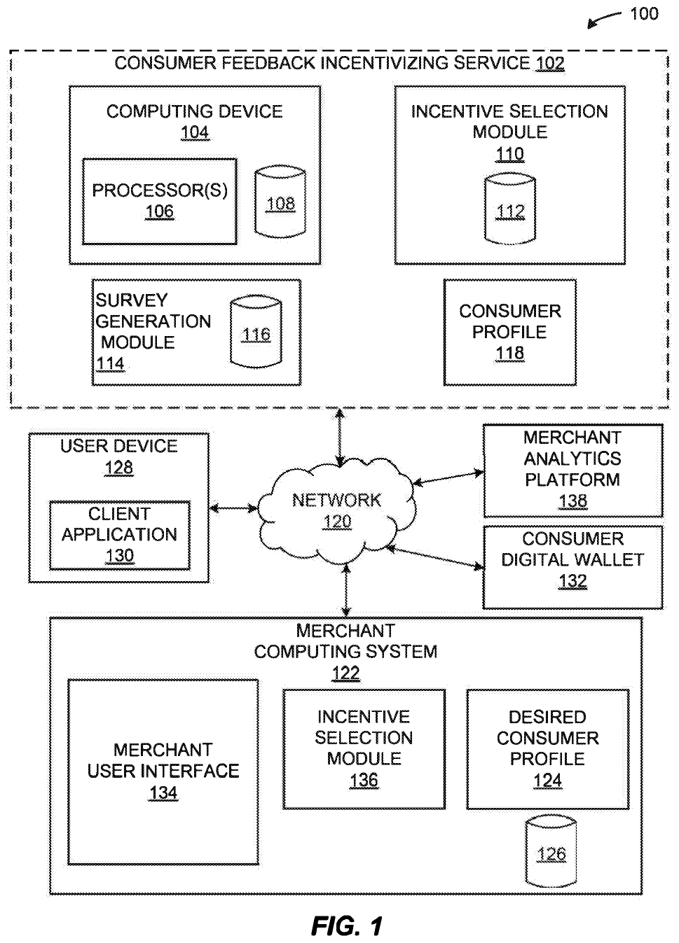

FIGS. 1 through 11, discussed below, and the various embodiments used to describe the principles of this disclosure are by way of illustration only and should not be construed in any way to limit the scope of the disclosure.

The example architecture 100 includes a network 120 that communicatively couples various devices, including the consumer feedback incentivizing service 102, user device 128, merchant computing system 122, and consumer digital wallet 132. The network 120 can include local area networks (LANs) and wide area networks (WANs). The network 102 can include wired technologies (e.g., Ethernet®) and wireless technologies (e.g., Wi-Fi®, code division multiple access (CDMA), near-field communication (“NFC”), global system for mobile (GSM), universal mobile telephone service (UMTS), Bluetooth®, and ZigBee®. For example, the user device 104 can use a wired connection or a wireless technology (e.g., Wi-Fi®) to transmit and receive data over the network 120.

In various implementations, all or a portion of the data may be primarily stored or backed up in a distributed ledger system such as, without limitation, blockchain. For example, consumer feedback data may be stored in a distributed ledger system for purposes of maintaining and improving the integrity of the data, which is collected from numerous, disparate devices and sources. Use of a distributed ledger may also enable easier sharing of relevant data across disparate platforms and organizations. A distributed ledger may, in some embodiments, be used to enable and track incentive availability, incentive reward histories, consumer profiles, etc. as further described herein. A distributed ledger may, in some embodiments, be used to enable certain data to be accessed only by authorized parties.

In an exemplary operation, consumer feedback incentivizing service 102 may be configured to select a consumer to provide feedback related to one or more transactions associated with the consumer. Consumer feedback incentivizing service 102 may then select a survey comprising one or more questions related to the one or more transactions associated with the consumer. For example, consumer feedback incentivizing service 102 may communicate information about the selected consumer and/or transaction(s) to survey generation module 114. In some embodiments, the information communicated to survey generation module 114 about the consumer may include all or part of a stored consumer profile 118. According to some embodiments, survey generation module 114 may then match the consumer or attributes of the consumer with one or more surveys stored in database 116 of survey generation module 114 and transmit the one or more selected surveys back to consumer feedback incentivizing service 102.

According to some embodiments, consumer feedback incentivizing service 102 may transmit, for display on a computing device of the consumer, the one or more selected surveys related to the one or more transactions associated with the consumer. The computing device may broadly be any user-operated device having computing hardware, however it should be understood that a typical implementation may include any device capable of operating wirelessly, such as a smartphone, tablet, laptop, or desktop computer. In particular, according to some embodiments, the device may be an electronic device owned, used, or otherwise controlled by a consumer. In other embodiments, the device may be an electronic device provided by, owned, or otherwise controlled by a merchant. As one example, a merchant may provide, on a customer-facing electronic device at a point of sale, an opportunity for the consumer to provide feedback during the transaction and/or immediately after completing the transaction. According to some embodiments, consumer feedback incentivizing service 102 transmits one or more surveys to user device 128 for display, via client application 130 showing on a user interface (e.g., a touch screen or other standard computing interface) of user device 128.

User device 128 may be any suitable computing device, such as a smartphone, tablet, or desktop or laptop computer. User device 128 may be include a user interface configured to execute a client application 130. Client application 130 may be implemented in computer instructions stored on one or more memory devices and executed by one or more processing devices of the user device 128. Client application 130 may be a standalone application installed on user device 128 or may be an application that is executed by another application, such as a website in a web browser.

Consumer feedback incentivizing service 102, according to some embodiments, may include a computing device 104 having one or more processors 106 for executing the tasks of consumer feedback incentivizing service 102 and a computing device database 108. Computing device 104 may be any suitable computing device such as a computer server, laptop, tablet, smartphone, or desktop or laptop computer. The one or more processors 106 may be configured to execute computer instructions stored on computing device 104 or elsewhere in consumer feedback incentivizing service 102. Database 108 of computing device 104 may store any data necessary to enable the operation of consumer feedback incentivizing service 102. For example, database 108 may include consumer profiles including information associated with consumer profile 118, incentive selection module 110, and/or survey generation module 114.

According to some embodiments, consumer feedback incentivizing service 102 may transmit, to incentive selection module 110, information related to the consumer and/or the one or more transactions. According to some embodiments, incentive selection module 110 may then match the consumer or attributes of the consumer with one or more incentives stored in database 112 of incentive selection module 110 and transmit information about the selected one or more incentives back to consumer feedback incentivizing service 102. Examples of incentives that may be available include the granting of retailer discounts on future purchases, contest entries, free goods or services redeemable at a particular merchant or franchise, reward program points, or any other suitable incentive reward as may be appropriate to the consumers and businesses involved.

Consumer feedback incentivizing service 102 may transmit, for display on a computing device of the consumer—for example, a smartphone—the one or more incentives selected by incentive selection module 110. According to some embodiments, consumer feedback incentivizing service 102 transmits information related to one or more incentives to user device 128 for display, via a client application 130 showing on a user interface of user device 128.

According to some embodiments, the consumer or other user of user device 128 may input a response to the one or more surveys at the user interface of user device 128. These responses may then be transmitted, via network 120, back to consumer feedback incentivizing service 102.

In response to receiving appropriate survey responses, according to some embodiments, consumer feedback incentivizing service 102 may fulfil the incentive offer. For example, according to some embodiments, consumer feedback incentivizing service may fulfil the incentive offer at least in part by communicating a coupon or voucher to the consumer via user device 128 or other contact information as may be available, for example as part of consumer profile 118. In some embodiments, consumer feedback incentivizing service 102 may fulfil the incentive offer at least in part by adding an incentive benefit to a digital wallet 132 associated with the consumer. For example, consumer feedback incentivizing service 102 may add an incentive reward of a free bagel at a local shop directly into the consumer's digital wallet. Digital wallet 132 according to some embodiments may be Apple Pay™, Google Pay™, Samsung Pay™, or any other suitable digital wallet or digital transaction facilitation application. In other embodiments, one or more digital wallets 132 may correspond to various prospective consumers, for example prospective consumers to whom gift incentives may be given.

According to some embodiments, some or all of consumer feedback incentivizing service 102 may be in communication one or more merchant computing systems 122. For example, a merchant, retailer, or other goods or service provider may establish one or more desired consumer profiles 124 stored in a database 126 of merchant computing system 122. The desired consumer profile(s) may define attributes of consumers that the merchant would like survey answers from. According to some embodiments, merchant computing system 122 may also provide survey preferences and/or survey questions provided by the merchant to consumer feedback incentivizing service 102 and/or survey generation module 114. According to some embodiments, merchant computing system 122 may also provide incentive preferences and/or information about available incentives to consumer feedback incentivizing service 102 and/or incentive selection module 110.

Merchant computing system 122 according to some embodiments may be any suitable computing devices such as a computer server, laptop, tablet, smartphone, or desktop or laptop computer. Database 126 of merchant computing system 122 may store any data necessary to enable the operation of merchant computing system 122.

Merchant computing system 122 may represent any computing system through which a merchant may access information about the consumer feedback and incentivizing services. For example, through merchant interface 134, a merchant may view information provided by merchant analytics platform 138.

According to some embodiments, a merchant may use incentive selection module 136 to define and activate various incentives that the merchant wants to use to incentivize its customers to provide prompt feedback. According to various embodiments, and as discussed in more detail herein, a merchant may also define one or more attributes for consumers it wishes to incentivize, for example by creating one or more desired consumer profiles 124.

Merchant analytics platform 138, according to various embodiments, may be a standalone application resident on a remote system. In other embodiments, merchant analytics platform 138 may reside elsewhere, for example as an application running on the merchant computing system 122 or on consumer feedback incentivizing service 102.

Merchant analytics platform 138, according to various embodiments, may collect and analyze consumer feedback data received by consumer feedback incentivizing service 102. For example, merchant analytics platform 138 may provide analysis related to one or more of customer comments, customer demographics, customer psychographics, merchant rating data, at least one estimate of consumers gained as a result of the merchant using the system, at least one estimate of the value of consumers gained as a result of the merchant using the system, an accounting of the value of incentives delivered by the system on the merchant's behalf, and data associated with one or more rates of success associated with at least one of the one or more incentive offers. This list is non-exhaustive, as numerous other analyses and reports may be provided, as would be apparent to one having ordinary skill in the art. In some implementations of the system, information may be displayed in any one or a combination of various forms—for example, visual forms, auditory forms, haptic forms, tactile forms, or any other appropriate form of information delivery as would be apparent to a person having ordinary skill in the art.

A merchant analytics platform 138, according to some embodiments may allow a merchant to download raw data. For example, a merchant may be able to select to download all available feedback data, or to define a particular set of data for download, for example by limiting the sample according to time, geography, customer type, customer attributes, or other demographic or psychographic data. Examples of information that may be downloaded and cross-referenced or otherwise analyzed by a merchant, according to some embodiments, include geographical location, star rating or other feedback rating data, survey completion percentage and other related data, purchase items and values, day and time of purchases and survey completions, and information related to gifted incentives.

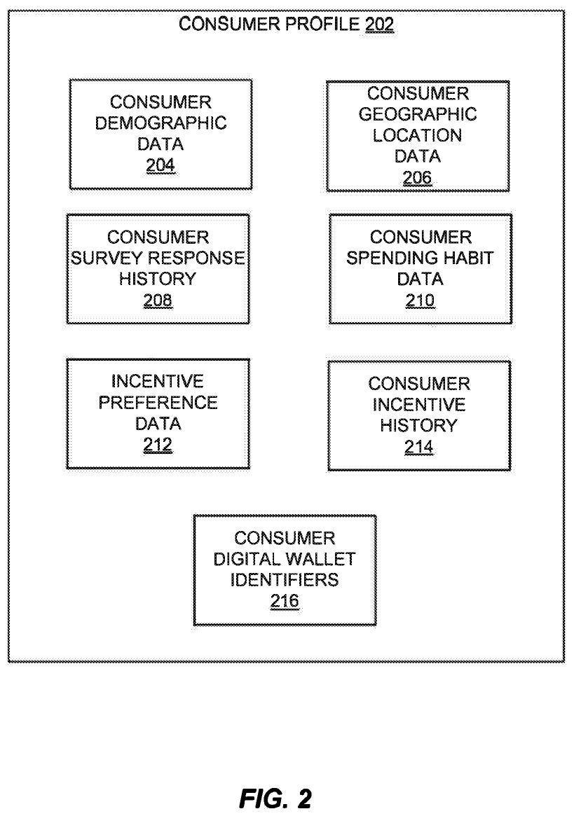

FIG. 2 illustrates details of an example consumer profile according to various embodiments. Consumer profile 202 according to some embodiments represents an individual consumer or consumer group. According to some embodiments, a consumer profile 118 of FIG. 1 may be arranged similar to or contain information similar to that described herein with respect to consumer profile 202 of FIG. 2. A desired consumer profile 124, according to some embodiments, may be arranged similar to or contain information similar to that described here with respect to consumer profile 202 of FIG. 2.

Consumer demographic data 204 of consumer profile 202 may include, according to some embodiments, demographic data associated with one or more consumers, such as age, gender, race, occupation, income, hobbies, location of residence, eating habits, and other suitable demographic information. Consumer demographic data 204 and other information of consumer profile 202 may be ultimately intended to provide a high level of granularity to a merchant when considering who is buying or may be likely to buy particular goods or services.

Consumer geographic location data 206 of consumer profile 202 may include, according to some embodiments, geographical location information such as Global Positioning System (“GPS”) or other suitable location information location related to a user's residence, workplace, common vacation or work travel locations, favorite restaurants, etc. Consumer geographic location data 206 may also include actual location history of an individual consumer or group (“cohort”) of consumers. According to some embodiments, consumer geographic location data 206 may include projections of likely future location information. Any location information of consumer geographic location data 206, according to some embodiments, may be stored with corresponding data and time stamp information.

Consumer survey response history 208 of consumer profile 202 includes, according to some embodiments, information related to whether, when, and how often one or more consumers associated with consumer profile 202—or people sharing certain actual, predictable or derivable attributes with those one or more consumers—have responded to previous survey questions presented to the one or more consumers associated with consumer profile 202. Such analysis may, in some embodiments, be aided by the use of various artificial intelligence or machine learning techniques, as appropriate. According to some embodiments, consumer survey response history 208 may include information related to the types of survey questions the one or more consumers associated with consumer profile 202 have responded to in the past, and/or projected attributes of survey questions the one or more consumers associated with consumer profile 202 may be likely to respond to in the future. In some embodiments, a consumer profile 202 may include projected attributes of consumers who are likely to respond to the survey questions that are available or expected to be available, or for which answers and feedback are desired.

Consumer spending habit data 210 of consumer profile 202 includes, according to some embodiments, information related to past purchases made by the one or more consumers associated with consumer profile 202. According to some embodiments, consumer spending habit data 210 of consumer profile 202 may further include projections related to likely future spending habits of the one or more consumers associated with consumer profile 202. According to some embodiments, information of consumer spending habit data may include purchase amounts and frequency of various types of purchases, and other appropriate consumer spending habit data as one having ordinary skill in the art would recognize.

Incentive preference data 212 and consumer incentive history 214 of consumer profile 202 include, according to some embodiments, information related to whether, when, and how often one or more consumers associated with consumer profile 202 have responded to previous incentives offered (consumer incentive history 214) in exchange for completing surveys. According to some embodiments, incentive preference data 212 may include information related to the types of incentives the one or more consumers associated with consumer profile 202 have responded to in the past and/or projected attributes of incentives the one or more consumers associated with consumer profile 202 may be likely to respond to in the future.

Consumer digital wallet identifier(s) 216, according to some embodiments, include any suitable digital wallet or digital transaction facilitation platforms associated with one or more consumers associated with consumer profile 202.

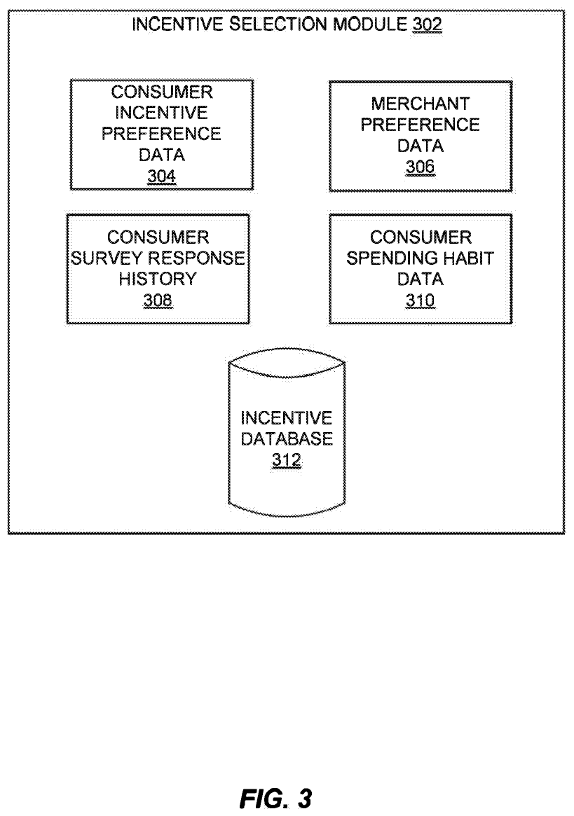

FIG. 3 illustrates details of an example incentive selection module according to various embodiments. Incentive selection module 110 of FIG. 1 may, in some embodiments, be arranged similar to or contain information similar to that described herein with respect to incentive selection module 302. Incentive selection module may be configured, inter alia, to combine known attributes of a selected consumer or group of consumers with a merchant's preference data and available incentives in order to select the best incentive match when taking into account various factors such as likelihood of response and how closely the targeted or selected consumer (also referred to herein as the “immediate consumer”) matches the merchant's preference.

Consumer incentive preference data 304, according to some embodiments, may include information related to the types of incentives the immediate consumer or group of consumers has responded to in the past and/or projected attributes of incentives the immediate consumer or group of consumers may be likely to respond to in the future.

Merchant preference data 306, according to some embodiments, may include any information provided by a merchant or merchants about a desired consumer that the merchant or merchants would like to have survey feedback data from. Merchant preference data, according to some embodiments, may be input via a merchant interface and survey results may be provided to the merchant through the same interface or another interface. According to some embodiments, merchant preference data may include some or all of the information of a desired consumer profile, which may be similar to a consumer profile 202 as discussed with respect to FIG. 2.

Consumer survey response history 308 includes, according to some embodiments, information related to whether, when, and how often one or more consumers have responded to previous survey questions presented to the immediate consumer or group of consumers. According to some embodiments, consumer survey response history 308 may include information related to the types of survey questions the consumer or group of consumers has responded to in the past, and/or projected attributes of survey questions the consumer or group of consumers may be likely to respond to in the future.

Consumer spending habit data 310 includes, according to some embodiments, information related to past purchases made by the immediate consumer or group of consumers. According to some embodiments, consumer spending habit data 310 may further include projections related to likely future spending habits of the immediate consumer or group of consumers. According to some embodiments, information of consumer spending habit data may include purchase amounts and frequency of various types of purchases, and other appropriate consumer spending habit data as one having ordinary skill in the art would recognize.

Incentive database 312, according to some embodiments, may be populated with incentives provided by merchants and available immediately, at any time in the future, and/or at other franchise locations or retailers—for example, a free drink or free donut at a local donut shop. According to some embodiments, incentive database 312 may also or alternatively include incentives generated by consumer feedback incentivizing service 102 or other appropriate sources.

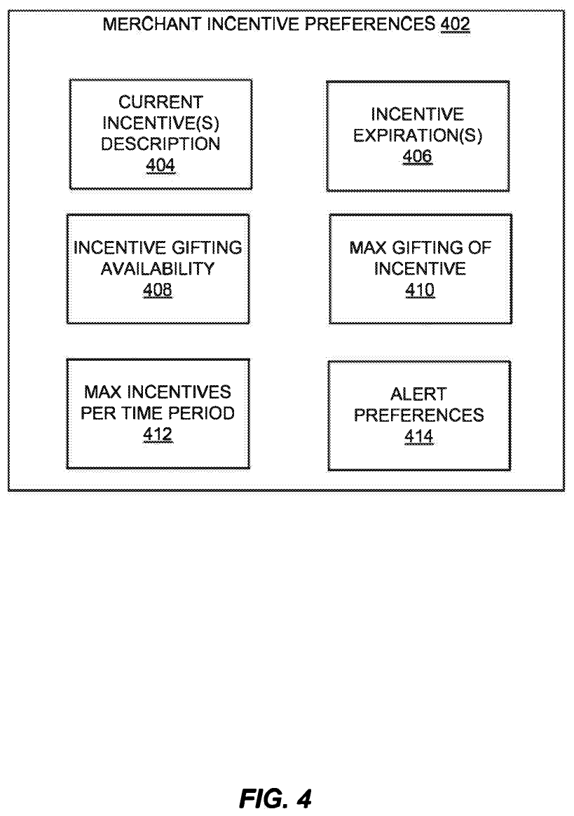

FIG. 4 illustrates a partial list of available merchant incentive preferences according to various embodiments. Merchant incentive preferences 402 according to some embodiments represent an individual merchant, retailer, or service provider or a group of merchants, retailers, or service providers. According to some embodiments, merchant incentive preferences may be communicated, for example, from a merchant computing system 122 to an incentive selection module 110 as described with reference to FIG. 1.

According to some embodiments, current incentive(s) description 404 includes details of what incentives are offered by a merchant or group of merchants, how long they are offered, which attributes of consumers, if any, are required in order to make the offer, and any other appropriate descriptive incentive details as one having ordinary skill in the art would recognize.

Incentive expiration information 406 of merchant incentive preferences 402 may include information including one or more expiration dates associated with available incentives or incentive descriptions 404. “Max incentives per time period” 412 of merchant incentive preferences 402 may define, according to some embodiments, the maximum number of incentives available to an individual consumer or group of consumers within a defined period of time. According to some embodiments, max incentives per time period 412 may define the maximum number of incentives associated with a particular merchant or group of merchants that may be made available to any party during a defined period of time.

Incentive gifting availability 408 of merchant incentive preferences 402 may include, according to some embodiments, information related to whether, how often, and how many times various incentives may be gifted from the original earner to third parties. For example, as described elsewhere herein and according to some embodiments, after the incentive has been fulfilled or delivered to a digital wallet of a consumer, the consumer may be presented with an option to gift the same or similar incentive to a third party, or to split a gift incentive among multiple parties. According to some embodiments, “max gifting of incentive” 410 may define, with regard to one or more incentives, a maximum number of times an incentive may be gifted during a defined period of time, during the life of the incentive, during the life of the consumer or merchant, or any other appropriate restriction as would be apparent to one having ordinary skill in the art.

According to some embodiments, alert preferences 414 may define the type and frequency of notifications provided to consumers and/or merchants regarding incentive status or earning.

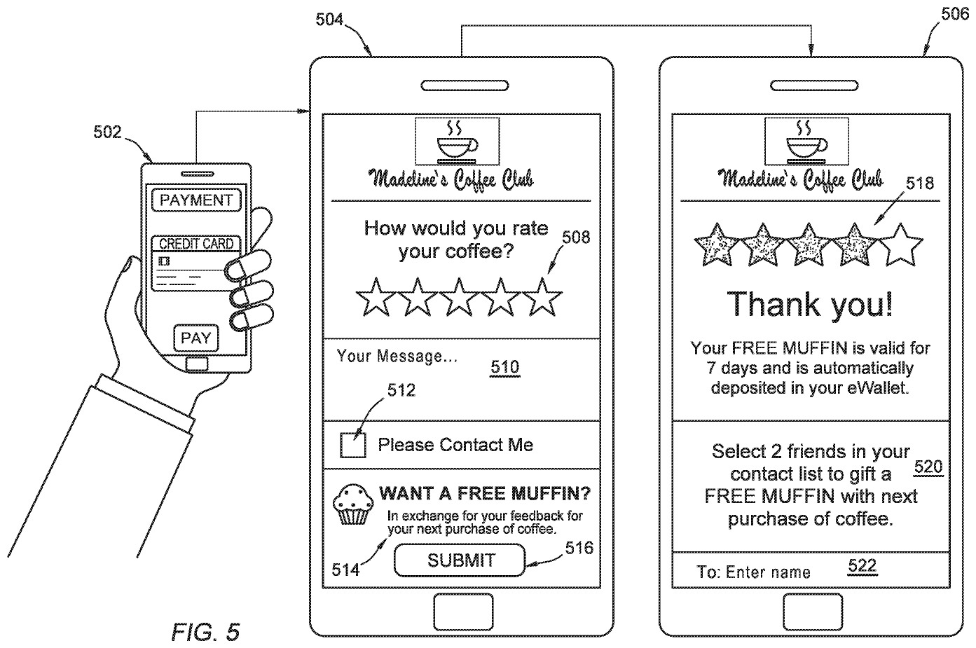

FIG. 5 illustrates example consumer device application screens according to some embodiments of the present invention. All aspects of the interface and content presented here are merely exemplary and shall not, for example, be understood to limit the disclosure to any particular user interface configuration.

Screen 502 shows an exemplary payment interface on a user device, for example user device 128 as described with reference to FIG. 1. At screen 502, a user is presented with options to complete payment associated with a purchase. According to some embodiments, this payment screen may be a digital wallet application itself or linked to a digital wallet of the user.

After payment is completed, according to some embodiments, the user is presented with screen 504. Interface 508 presents, as an example, a survey question in the simple and familiar “star rating” format. The commonly used “star rating” format is merely exemplary, and numerous other simple rating systems are available, as would be apparent to one having ordinary skill in the art. Field 510 according to some embodiments allows the user to type a message to the retailer if desired.

According to some embodiments, selection 512 of screen 504 allows the user to specify that the user would like to be contacted by the merchant, for example in the event the user has a complaint or praise to share regarding the goods or services of the merchant or service provider.

At location 514 of screen 504, according to some embodiments, an incentive is presented to the user to entice the user to complete the survey question 508. According to some embodiments, submit button 516 allows the user to choose to claim the incentive offered at location 514 of screen 504.

After completion of the survey question 508 of screen 504 and claiming the incentive offered at location 514 of screen 504, the user is presented, according to some embodiments, with screen 506 or similar. Interface location 518 displays, according to the exemplary embodiment, the results of the consumer or user's response to survey question 508.

At location 520 of screen 506, the user is presented, according to some embodiments, with an offer to gift an incentive to one or more third parties. According to some embodiments, field 522 of screen 506 allows the user to enter identification information of one or more third parties to receive a gifted incentive. For example, a user may enter into field 522 one or more e-mail addresses, digital wallet IDs, phone numbers, messenger application IDs, biometric information, encryption or other keys, or other appropriate identification information as would be apparent to one having ordinary skill in the art.

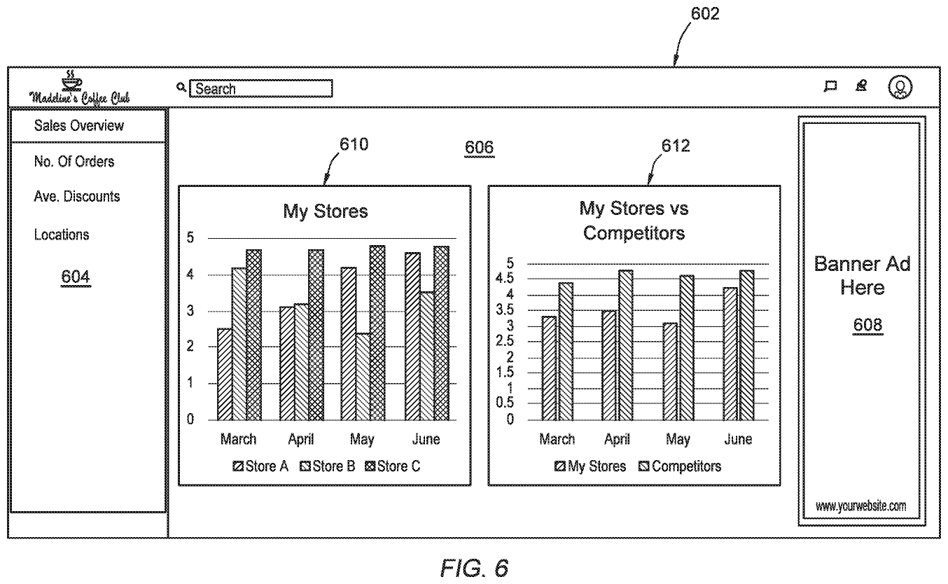

FIG. 6 illustrates an example merchant dashboard display according to some embodiments of the present invention. Example display 602, according to some embodiments, may be delivered via a merchant dashboard or merchant analytics platform. In some embodiments, the content of example display 602 may be delivered via a web browser or via the screen of a mobile device associated with the merchant. According to some embodiments, display 602 may include an advertising banner for displaying targeted advertisements to a merchant/user, as represented at location 608 of FIG. 6.

Area 604 of example display 602 represents one of a plurality of display sections, which may be similar or identical to a display frame or window. According to some embodiments, area 604 may offer one or more choices related to the types of data to be displayed in one or more other areas of display 602. In the example of FIG. 6, the choices “Sales Overview”, “No. Of Orders”, “Avg. Discounts”, and “Locations” are available to the merchant/user. In the example of FIG. 6, “Sales Overview” has been selected.

According to some embodiments, representations related to received feedback data may be displayed in area 606. In the example display of FIG. 6, a bar chart is displayed at area 610, the bar chart representing an average feedback score trend for three locations of a retailer over four months. Also in the example display of FIG. 6, a bar chart is presented at area 612, the bar chart representing a comparison of a merchant's average feedback scores over four months compared with similar competitors within a certain geographical radius or defined geographical area. The screens of FIG. 6 are exemplary only, as numerous other comparisons may be made, and numerous other analyses and reports may be provided, as would be apparent to one having ordinary skill in the art.

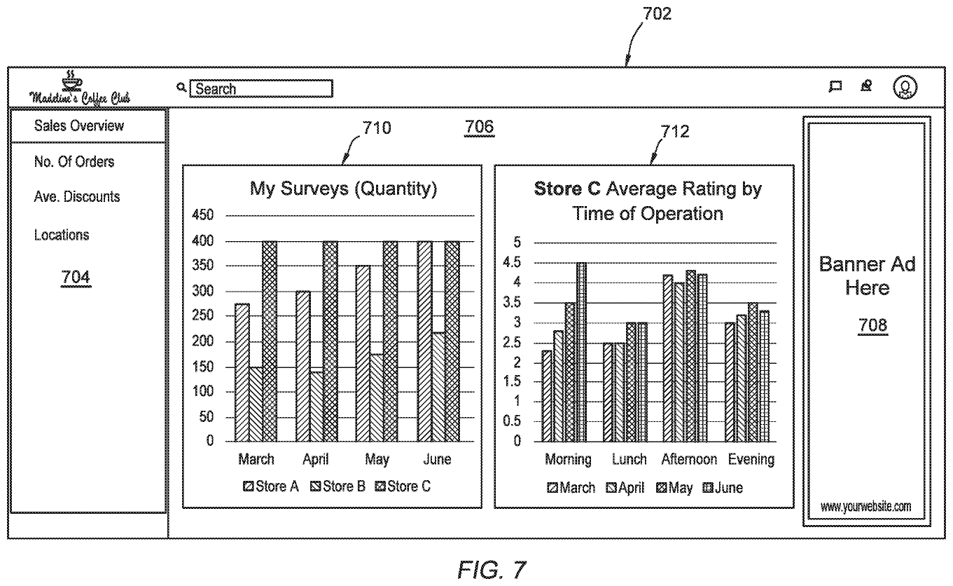

FIG. 7 illustrates another example merchant dashboard display according to some embodiments of the present invention. Example display 702, according to some embodiments, may be delivered via a merchant dashboard or merchant analytics platform. In some embodiments, the content of example display 702 may be delivered via a web browser or the screen of a mobile device associated with the merchant. According to some embodiments, display 702 may include an advertising banner for displaying targeted advertisements to a merchant/user, as represented at location 708 of FIG. 7.

Area 704 of example display 702 represents one of a plurality of display sections, which may be similar or identical to a display frame or window. According to some embodiments, area 704 may offer one or more choices related to the types of data to be displayed in one or more other areas of display 702. In the example of FIG. 7, the choices “Sales Overview,” “No. Of Orders,” “Avg. Discounts,” and “Locations” are available to the merchant/user. In the example of FIG. 7, “Sales Overview” has been selected.

According to some embodiments, representations related to received feedback data may be displayed in area 706. In the example display of FIG. 7, a bar chart is displayed at area 710, the bar chart representing a quantity of feedback surveys received over four months for three locations of a retailer. Also in the example display of FIG. 7, a bar chart is presented at area 712, the bar chart representing a comparison of a merchant's average feedback scores by time of operation (morning, lunch, afternoon, and evening) over four months. The screens of FIG. 7 are exemplary only, as numerous other comparisons may be made, and numerous other analyses and reports may be provided, as would be apparent to one having ordinary skill in the art.

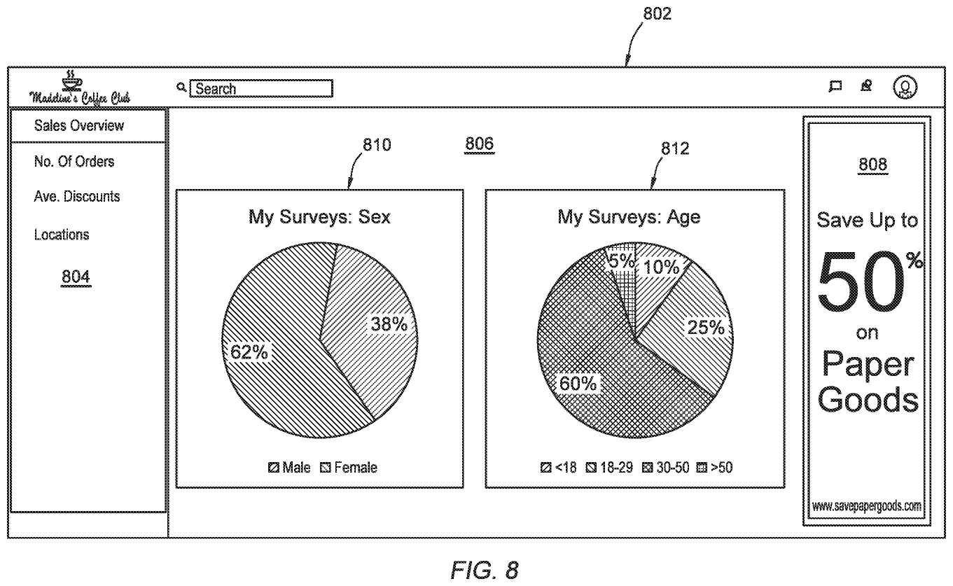

FIG. 8 illustrates yet another example merchant dashboard display according to some embodiments of the present invention. Example display 802, according to some embodiments, may be delivered via a merchant dashboard or merchant analytics platform. In some embodiments, the content of example display 802 may be delivered via a web browser or the screen of a mobile device associated with the merchant. According to some embodiments, display 802 may include an advertising banner for displaying targeted advertisements to a merchant/user, as represented at location 808 of FIG. 8. In the example of FIG. 8, the merchant is presented with an example advertisement for “50% off” of paper goods at a particular retailer.

Area 804 of example display 802 represents one of a plurality of display sections, which may be similar or identical to a display frame or window. According to some embodiments, area 804 may offer one or more choices related to the types of data to be displayed in one or more other areas of display 802. In the example of FIG. 6, the choices “Sales Overview,” “No. Of Orders,” “Avg. Discounts,” and “Locations” are available to the merchant/user. In the example of FIG. 8, “Sales Overview” has been selected.

According to some embodiments, representations related to received feedback data may be displayed in area 806. In the example display of FIG. 8, a pie chart is displayed at area 810, the pie chart representing the percentage of feedback surveys received according to the gender of the consumer completing the feedback survey. Also in the example display of FIG. 8, a pie chart is presented at area 812, the pie chart representing a breakdown of the percentage of feedback surveys completed in four age groups—<18, 18-29, 30-50, and >50 years of age. The screens of FIG. 8 are exemplary only, as numerous other charts may be constructed and provided, including charts and infographics of all forms, and numerous other analyses and reports may be provided, as would be apparent to one having ordinary skill in the art.

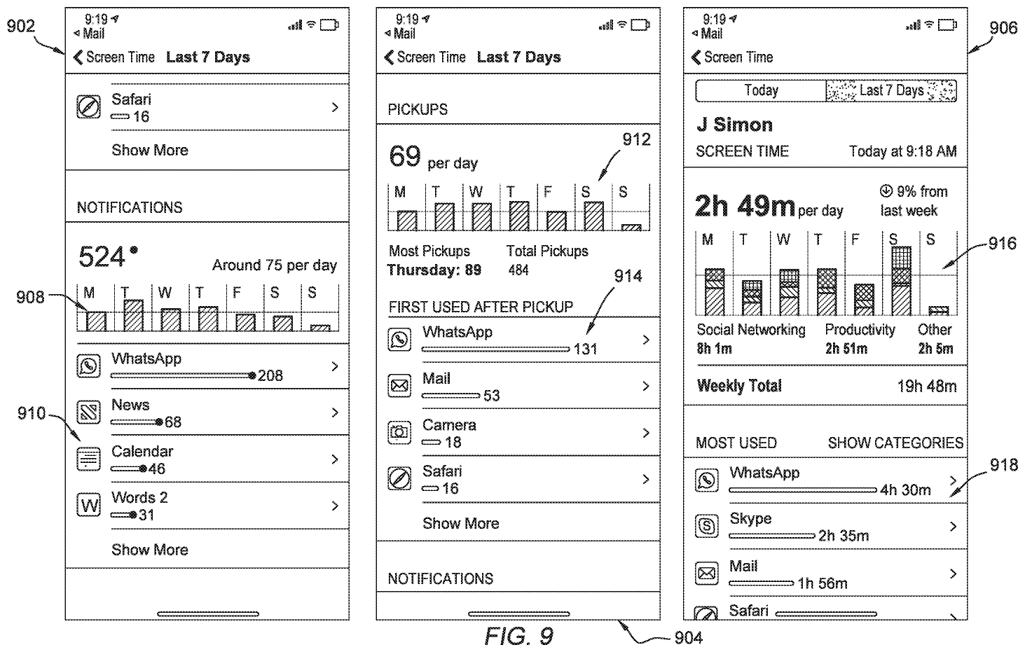

FIG. 9 illustrates an example merchant mobile device dashboard display according to some embodiments of the present invention. At example display 902, section 908 displays a bar graph representing the number of surveys sent each day of the current week. At section 910 of example mobile screen 902, information is displayed related to the first-used applications on consumer devices, where such first use immediately follows the notification of the request for feedback or survey completion.

At example display 904, section 912 displays a bar graph representing the number of feedback responses received each day of the current week. At section 914 of example mobile screen 904, information is displayed related to the first-used applications on consumer devices immediately following completion by the consumer of a feedback survey. According to some embodiments, example display 904 may alternatively or additionally include information about responses to gift incentive offers, including for example how many gift incentives are available, how many gift incentives have been transferred, data related to conversion of prospective consumers who receive gift incentives into regular customers of the merchant, etc.

At example display 906, section 916 displays a bar graph representing the estimated time spent by the merchant each day of the week related to three categories: “Social Networking,” “Productivity,” and “Other.” At section 918 of example mobile screen 906, information is displayed showing the most-used applications by time on the merchant's mobile device. The screens of FIG. 9 are exemplary only, as numerous other screens may be constructed and displayed, and numerous other analyses and reports may be provided, as would be apparent to one having ordinary skill in the art.

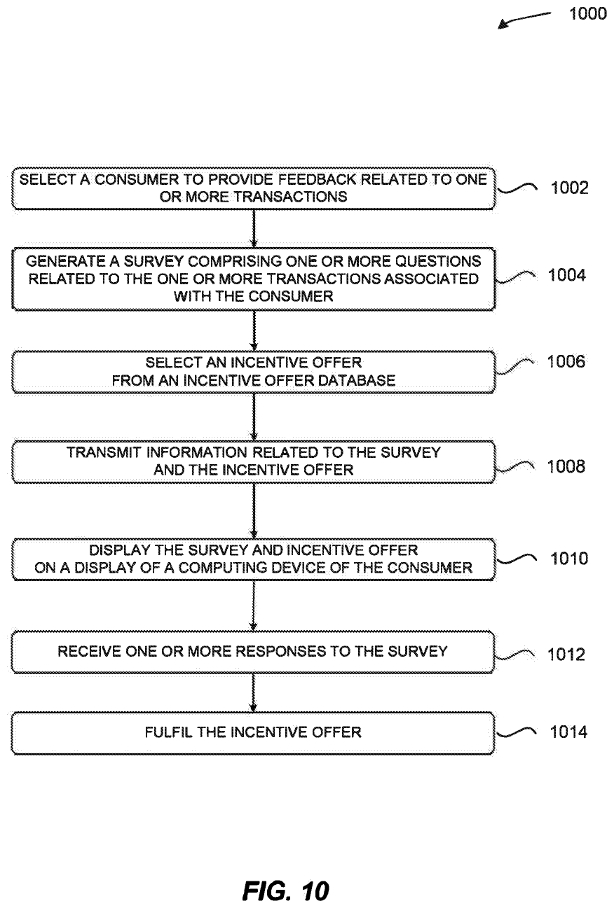

FIG. 10 represents a flowchart 1000 for a method of receiving real-time consumer transactional feedback. According to some embodiments, some or all of the steps of flowchart 1000 may be carried out by a system like system 100 as described with reference to FIG. 1.

At step 1002, a consumer is selected to provide feedback related to one or more transactions conducted by the consumer. According to some embodiments, the consumer may be selected based on matching attributes of a desired consumer profile provided by a merchant. In some embodiments, a consumer may be selected at least in part on the basis of the consumer having transacted business with a particular merchant or set of merchants that have requested that all of that merchant's or set of merchants' customers be surveyed.

At step 1004, a survey is generated for the consumer, the survey comprising one or more questions related to the one or transactions associated with the consumer. As just a few examples, a survey question may simply ask for a general level of satisfaction with the merchant's services, with the merchant's product offering, or with the transaction generally.

At step 1006, an incentive offer is selected. According to some embodiments, the incentive offer may be selected from an incentive database, for example because the consumer or transaction matches attributes of a desired consumer profile provided by a merchant.

At step 1008, according to some embodiments, information related to the survey and the incentive offer is transmitted to the user or the user's device. In a typical embodiment, the survey and incentive offer may be presented to the consumer on the consumer's computing device (e.g., smartphone) via a touch user interface (step 1010). In some embodiments, the incentive offer is presented to entice the user to complete the survey. In some embodiments, the computing device may present selectable options to select certain incentive offer(s) to claim when responding to the survey.

At step 1012, a response to the survey is received from the user or consumer. For example, in a typical implementation, a consumer might use a touch screen of the consumer's device to complete the survey.

At step 1014, in response to receiving the survey response (according to some embodiments, a prerequisite for obtaining the incentive), the incentive is fulfilled. For example, the incentive information may be transmitted to the consumer's device or directly to the consumer's smart or digital wallet. In some embodiments, in response to receiving the survey response (e.g., survey feedback data), the incentive offer may be deposited directly into the digital wallet executing on the computing device of the user that answered the survey. The incentive offers may be automatically used when the user uses the computing device to perform a transaction associated with a good or service pertaining to the incentive offer.

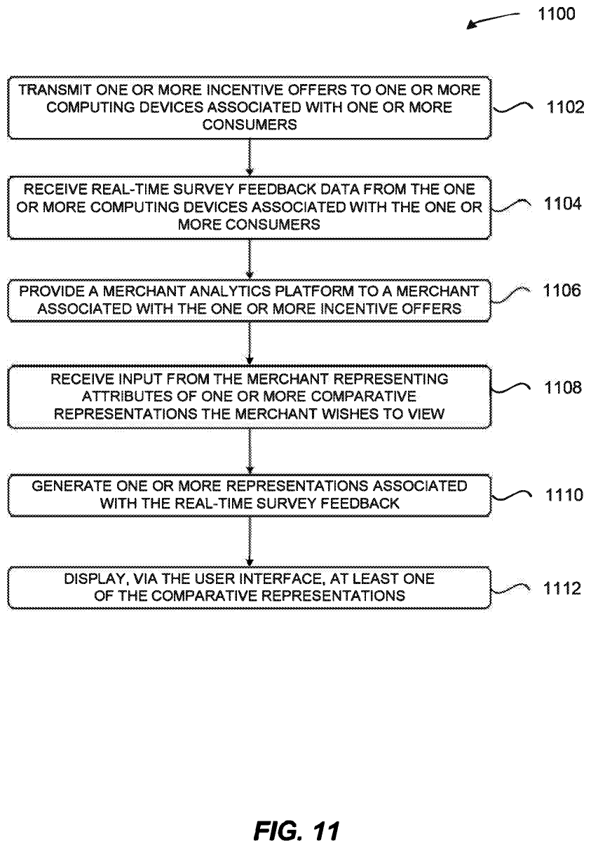

FIG. 11 represents a flowchart for a method of operating a consumer feedback system that includes a comparative merchant analytics platform, according to some embodiments of this disclosure.

At step 1102 of the example method of FIG. 11, one or more incentive offers are transmitted to one or more computing devices associated with one or more consumers. According to some embodiments, the consumers may be selected according to any of the methods and parameters discussed elsewhere herein.

At step 1104, according to some embodiments, real-time survey feedback data is received from the one or more computing devices associated with the one or more consumers. As discussed herein, “real-time” in this context shall not be construed to strictly require immediate feedback.

At step 1106, according to some embodiments, a merchant is provided with access to a merchant analytics platform (or dashboard). The merchant may, according to various embodiments, access this platform via a web browser, a mobile application, or any other suitable method as would be apparent to a person having ordinary skill in the art.

At step 1108 of the example method of FIG. 11, according to some embodiments, the system may receive input from a merchant indicating one or more attributes—for example, any of the potential comparative attributes described herein or others as would be obvious to one having ordinary skill in the art. These attributes may, at least in part, define various comparative representations that the merchant wishes to view.

At step 1110, according to some embodiments, the system may generate one or more representations associated with the real-time survey feedback. In some embodiments, these representations may be generated at least in part using the input received from the merchant regarding any of the potential comparative attributes described herein or others as would be obvious to one having ordinary skill in the art. For example, any representation similar to the graphical representations of FIGS. 6-9, or other data and representations as appropriate, may be generated according to various embodiments.

In various embodiments the one or more representations may comprise comparative representations of a merchant's customer satisfaction performance—for example, representations of the merchant's performance compared to other merchants or various outlets associated with the merchant. In some embodiments, at least one comparative representation may be selected from: a comparison of at least a portion of the real-time survey feedback data associated with the merchant to feedback data associated with one or more other merchants in a similar industry as the merchant; a comparison of at least a portion of the real-time survey feedback data associated with the merchant to feedback data associated with one or more other merchants in a specified geographic area; and a comparison of at least a portion of the real-time survey feedback data associated with the merchant to feedback data associated with one or more other merchants selected by the merchant.

In some embodiments, one or more of the selections or representations may include a time-based limitation of data. For example, comparative representations according to some embodiments may include only data from a specified time period. In some embodiments of the system, at least one of the one or more comparative representations may comprise a comparison of the merchant's performance to one or more other stores, e.g. franchises or company-owned stores, of the merchant. In some embodiments, one or more of the selections or representations may comprise a geographical limitation. In some embodiments, at least one of the one or more comparative representations may comprise a graphical presentation of at least some of the real-time survey feedback data.

At step 1112, according to some embodiments, the system may display, via the user interface, one or more comparative representations as generated in step 1110.

None of the descriptions in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. A system comprising:
one or more hardware processors configured by machine-readable instructions to:
transmit one or more incentive offers to one or more computing devices associated with one or more consumers;
receive real-time survey feedback data from the one or more computing devices associated with the one or more consumers; and
receive one or more selections from the merchant, the selections representing attributes of one or more comparative representations the merchant wishes to view.

2. The system of claim 1, wherein the one or more hardware processors are further configured to display, via a user interface, at least one of the one or more comparative representations.

3. The system of claim 1, wherein the one or more hardware processors are further configured to provide a merchant analytics platform to a merchant associated with the one or more incentive offers, the merchant analytics platform comprising a user interface, wherein the user interface of the merchant analytics platform comprises a plurality of analytics display sections.

4. The system of claim 1, wherein at least one of the one or more comparative representations comprises at least a portion of the real-time survey feedback associated with the merchant compared with feedback data associated with one or more competitors of the merchant.

5. The system of claim 1, wherein the one or more comparative representations comprise at least one representation selected from:
a comparison of at least a portion of the real-time survey feedback data associated with the merchant to feedback data associated with one or more other merchants in a similar industry as the merchant;
a comparison of at least a portion of the real-time survey feedback data associated with the merchant to feedback data associated with one or more other merchants in a specified geographic area; and
a comparison of at least a portion of the real-time survey feedback data associated with the merchant to feedback data associated with one or more other merchants selected by the merchant.

6. The system of claim 1, wherein one or more of the selections comprises a time-based limitation.

7. The system of claim 1, wherein at least one of the one or more comparative representations comprises a comparison of the merchant's performance to one or more other stores of the merchant.

8. The system of claim 1, wherein one or more of the selections comprises a geographical limitation.

9. The system of claim 1, wherein at least one of the one or more comparative representations comprises a graphical presentation of at least some of the real-time survey feedback data.

10. The system of claim 2, wherein the user interface is displayed on a mobile application of a mobile device associated with the merchant.

11. The system of claim 2, wherein the user interface is displayed in a web browser.

12. The system of claim 3, wherein at least one of the plurality of analytics display sections is configurable by the merchant.

13. A method of operating an analytics platform of a consumer feedback incentive system, the method comprising:
transmitting one or more incentive offers to one or more computing devices associated with one or more consumers;
receiving real-time survey feedback data from the one or more computing devices associated with the one or more consumers; and
receiving one or more selections from the merchant, the selections representing attributes of one or more comparative representations the merchant wishes to view.

14. The method of claim 13 further comprising displaying, via a user interface, at least one of the one or more comparative representations.

15. The method of claim 13 further comprising providing a merchant analytics platform to a merchant associated with the one or more incentive offers, the merchant analytics platform comprising a user interface, wherein the user interface of the merchant analytics platform comprises a plurality of analytics display sections.

16. The method of claim 13, wherein at least one of the one or more comparative representations comprises at least a portion of the real-time survey feedback associated with the merchant compared with feedback data associated with one or more competitors of the merchant.

17. The method of claim 13, wherein the one or more comparative representations comprise at least one representation selected from:
a comparison of at least a portion of the real-time survey feedback data associated with the merchant to feedback data associated with one or more other merchants in a similar industry as the merchant;
a comparison of at least a portion of the real-time survey feedback data associated with the merchant to feedback data associated with one or more other merchants in a specified geographic area; and
a comparison of at least a portion of the real-time survey feedback data associated with the merchant to feedback data associated with one or more other merchants selected by the merchant.

18. The method of claim 13, wherein one or more of the selections comprises a time-based limitation.

19. The method of claim 13, wherein at least one of the one or more comparative representations comprises a comparison of the merchant's performance to one or more other stores of the merchant.

20. The method of claim 13, wherein one or more of the selections comprises a geographical limitation.

21. The method of claim 15, wherein at least one of the plurality of analytics display sections is configurable by the merchant.

22. The method of claim 14, wherein the graphical user interface is displayed on a mobile application of a mobile device associated with the merchant.

23. The method of claim 14, wherein the graphical user interface is displayed in a web browser.

24. A non-transient computer-readable storage medium having instructions embodied therein, the instructions being executable by one or more processors to perform a method comprising:
transmitting one or more incentive offers to one or more computing devices associated with one or more consumers;
receiving real-time survey feedback data from the one or more computing devices associated with the one or more consumers;
providing a merchant analytics platform to a merchant associated with the one or more incentive offers, the merchant analytics platform comprising a user interface, wherein the user interface of the merchant analytics platform comprises a plurality of analytics display sections;
receiving one or more selections from the merchant, the selections representing attributes of one or more comparative representations the merchant wishes to view; and
displaying, via the user interface, at least one of the one or more comparative representations.

25. The non-transient computer-readable storage medium of claim 24, wherein the method further comprises displaying, via a user interface, at least one of the one or more comparative representations.

26. The non-transient computer-readable storage medium of claim 24, wherein at least one of the one or more comparative representations comprises at least a portion of the real-time survey feedback associated with the merchant compared with feedback data associated with one or more competitors of the merchant.

27. The non-transient computer-readable storage medium of claim 24, wherein the one or more comparative representations comprise at least one representation selected from:
a comparison of at least a portion of the real-time survey feedback data associated with the merchant to feedback data associated with one or more other merchants in a similar industry as the merchant;
a comparison of at least a portion of the real-time survey feedback data associated with the merchant to feedback data associated with one or more other merchants in a specified geographic area; and
a comparison of at least a portion of the real-time survey feedback data associated with the merchant to feedback data associated with one or more other merchants selected by the merchant.
